(19) United States
(12) Patent Application Publication
(10) Pub. No.: US 2024/0384035 A1
(43) Pub. Date: Nov. 21, 2024

(54) Controlling Curing Kinetics and Network Structure of Polysiloxanes Using Curing Accelerators and Inhibitors

(71) Applicant: Lawrence Livermore National Security, LLC, Livermore, CA (US)

(72) Inventors: Michael FORD, Livermore, CA (US); Jeremy M. LENHARDT, Livermore, CA (US)

(21) Appl. No.: 18/197,603

(22) Filed: May 15, 2023

(51) Int. Cl. C08G 77/12; B29C 64/118; B29C 64/129; B29C 64/30; B29C 71/04; B33Y 10/00; B33Y 40/20; B33Y 70/00

(52) U.S. Cl. CPC C08G 77/12; B29C 64/118; B29C 64/129; B29C 64/30; B29C 71/04; B33Y 10/00; B33Y 40/20; B33Y 70/00; B29K 2083/00

(57) ABSTRACT

A composition for forming a siloxane elastomer material includes a siloxane monomer having at least one silane functional group, a hydrosilylation catalyst, and a radical initiator. A curing accelerator for converting a thermal-curable siloxane resin to a radiation-curable siloxane resin includes a radical initiator and a photosensitizing agent.

This invention was made with Government support under Contract No. DE-AC52-07NA27344 awarded by the United States Department of Energy. The Government has certain rights in the invention.

### FIELD OF THE INVENTION

The present invention relates to siloxane resins for forming siloxane elastomer material, and more specifically to controlling curing kinetics and network structure of polysiloxanes using a curing accelerator and/or inhibitor mixture and methods and/or products thereof.

### BACKGROUND

Hydrosilylation of vinyl-terminated polysiloxanes is an important reaction mechanism for the preparation of organosilicon compounds. One common example of this reaction primarily relies on the crosslinking of a vinyl-terminated polysiloxane macromer with a polysiloxane with hydride functionality along its backbone. This reaction proceeds to form a crosslinked elastomer, and by varying the individual components of the composition, the mechanical properties can be tuned so that useful elastomer material (e.g., rubbers) can be used for a variety of applications.

More recently, a mechanism was proposed for the reaction of compositions that contained only one polysiloxane (a hydride functional polysiloxane) with a platinum catalyst. This reaction proceeds in the presence of water and oxygen, and the mechanism proposed suggests that water and oxygen form peroxyl and hydroxyl radicals that react with the macromer after a hydrogen is abstracted by the platinum catalyst. However, the formation of peroxyl and hydroxyl radicals is a rate-limiting step and, although possible, does not produce products in reasonable time duration. For example, the reported reaction that forms a silicone elastomer using this radical-formation reaction process includes significant added heat in order to cure during a reasonable time scale, e.g., temperatures at 100° C. to 150° C. for at least 24 hours. For additive manufacturing processes, the long cure time is disadvantageous for forming three-dimensional (3D) structure by direct ink writing (DIW).

Although a single reactant that forms silicone elastomers is desirable, a process including a simplified composition having a realistic cure time without added heat remains elusive. Moreover, it would be desirable for a silicone composition to be applicable to the photocuring process of stereolithography techniques.

### SUMMARY

In one embodiment, a composition for forming a siloxane elastomer material includes a siloxane monomer having at least one silane functional group, a hydrosilylation catalyst, and a radical initiator.

In another embodiment, a curing accelerator for converting a thermal-curable siloxane resin to a radiation-curable siloxane resin includes a radical initiator and a photosensitizing agent.

In yet another embodiment, a method of forming a three-dimensional (3D) structure includes obtaining a composition, where the composition includes a siloxane monomer having at least one silane functional group, a radical initiator, and a hydrosilylation catalyst, forming the 3D structure using the composition as a resin and/or ink with an additive manufacturing process, and curing the formed 3D structure for forming a siloxane elastomer material.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 depicts a series of schematic drawings of reactions included in a curing reaction of silane-terminated siloxanes in the presence of a radical initiator, according to one embodiment. Part (a) is the hydrogen abstraction of a silane-terminated siloxane monomer, part (b) is the oxidation of a methyl group to form a carbon radical, part (c) is the formation of branching structures by coupling carbon radicals, and part (d) is the formation of branching structures by a combination of silane-terminated siloxane monomers and vinyl-functionalized siloxane monomers.

FIG. 2 is a flow chart of a method of forming a three-dimensional structure using the siloxane composition with a radical initiator, according to one embodiment.

FIG. 3 is an image of a three-dimensional structure formed with a composition as described herein, according to one embodiment.

FIG. 4, part (a) is a plot of the curing kinetics of siloxane compositions having different hydride terminated PDMS monomers, according to one embodiment. Part (b) is a plot of the concentration of hydrogen (H) at the different measured curing times of the compositions of part (a).

FIG. 5 is a plot of the effect on the curing kinetics of adding a vinyl functionalized siloxane monomer in the composition having a silane-terminated siloxane monomer, according to one embodiment.

FIG. 6 is a plot of the curing kinetics of siloxane compositions having varying concentrations of thermally activated initiator, according to one embodiment.

FIG. 7 is a plot of the curing kinetics of compositions having a thermally activated initiator and a photoactivated initiator, according to one embodiment.

FIG. 8 is a plot of the curing kinetics (part (a)) of compositions having a thermally activated initiator and different types of photoactivated initiators, according to one embodiment. Part (b) depicts the structures of the different types of photoactivated initiators added to the compositions of part (a).

FIG. 9 depicts a plot of the curing kinetics of a composition with a photoactivated initiator in the presence of light and in the absence of light, according to one embodiment.

### DETAILED DESCRIPTION

The following description is made for the purpose of illustrating the general principles of the present invention and is not meant to limit the inventive aspects claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C. ±5° C., etc.

As used herein, the term “essentially” denotes an interval of accuracy that ensures a meaning of “mostly” but may not be exclusively 100%. The term “essentially” may denote 99.0% to 99.9%.

It is also noted that, as used in the specification and the appended claims, wt. % is defined as the percentage of weight of a particular component relative to the total weight/mass of the formulation. Vol. % is defined as the percentage of volume of a particular compound relative to the total volume of the formulation or compound. Mol. % is defined as the percentage of moles of a particular component relative to the total moles of the formulation or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

In addition, the present disclosure includes several descriptions of a “resin” used in an additive manufacturing process to form the inventive aspects described herein. It should be understood that “resins” (and singular forms thereof) may be used interchangeably and refer to a composition of matter comprising a plurality of particles, small molecules, etc. coated with and dispersed throughout a liquid phase. In some inventive approaches, the resin may be optically transparent having a greater than 90% transmittance of light. In some inventive approaches, the resin is light sensitive where exposure to a particular light source changes the physical and/or chemical properties of the resin.

The following description discloses several preferred structures formed via photo polymerization processes, e.g., projection microstereolithography, photolithography, two photon polymerization, etc., or other equivalent techniques and therefore exhibit unique structural and compositional characteristics conveyed via the precise control allowed by such techniques. The physical characteristics of a structure formed by photo polymerization processes may include fabrication of a solid micro-structure having complex geometric arrangement of ligaments, filaments, etc. The three-dimensional structure formed from a resin exposed to light, wherein a pattern in the photoresist is created by the exposing light.

The following description discloses several preferred inventive aspects of controlling curing kinetics and network structure of polysiloxanes using thermally activated and photoactivated initiators and radical inhibitors and/or related systems and methods.

In one general embodiment, a composition for forming a siloxane elastomer material includes a siloxane monomer having at least one silane functional group, a hydrosilylation catalyst, and a radical initiator.

In another general embodiment, a curing accelerator for converting a thermal-curable siloxane resin to a radiation-curable siloxane resin includes a radical initiator and a photosensitizing agent.

In yet another general embodiment, a method of forming a three-dimensional (3D) structure includes obtaining a composition, where the composition includes a siloxane monomer having at least one silane functional group, a radical initiator, and a hydrosilylation catalyst, forming the 3D structure using the composition as a resin and/or ink with an additive manufacturing process, and curing the formed 3D structure for forming a siloxane elastomer material.

A list of acronyms used in the description is provided below.

| | |
|---|---|
| 3D | three-dimensional |
| AM | additive manufacturing |
| C. | Celsius |
| DIW | direct ink writing |
| nm | nanometer |
| ppm | parts per million |
| Pt | Platinum |
| μm | micron |
| SLA | stereolithography |
| UV | ultraviolet |
| wt. % | weight percent |

Conventional hydrosilylation of silicone elastomers includes the coupling of siloxanes with hydride and vinyl chemical functionalities with the addition of an appropriate catalyst (e.g., platinum-based catalysts). A recent study reports silicone elastomers can be prepared using a platinum catalyst and a siloxane with hydride chemical functionalities. In particular, in the recent study, siloxanes may not include vinyl functionalities, although siloxanes having vinyl functionalities may be included. The proposed mechanism in the study suggests that the reaction for elastomer formation relies on the presence of water and/or oxygen to form peroxides that allow crosslinking between the siloxane molecules.

According to one embodiment described herein, a composition for forming a siloxane elastomer material includes a hydride-terminated siloxane monomer, a hydrosilylation catalyst, and a radical initiator. In one approach, the composition may include only species of hydride-terminated siloxane monomers. In other approaches, the composition may include hydride-terminated siloxane monomers in combination with the a vinyl-terminated siloxane monomer.

As described herein, according to one embodiment, a radical initiator may be added to hydride siloxane formulations to modify the reaction kinetics of a peroxide-based crosslinking reaction. In one approach, a thermally initiated peroxide (e.g., a thermally activated initiator) can be added to increase the rate of reaction. In another approach, a peroxide that generates radicals via photoinitiation may allow for controllable photoinitiation of the crosslinking reaction. Furthermore, radical inhibitors/scavengers may be used to decrease the rate of reaction.

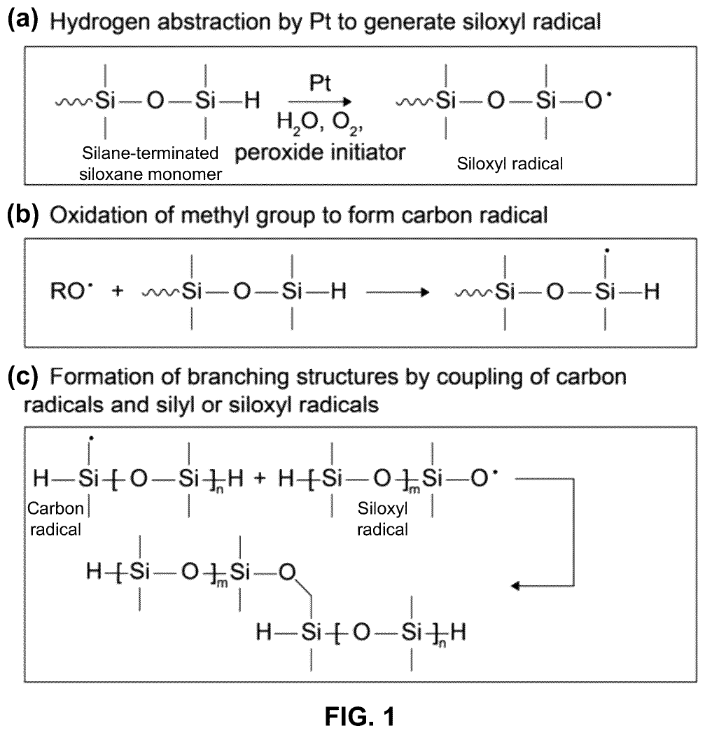

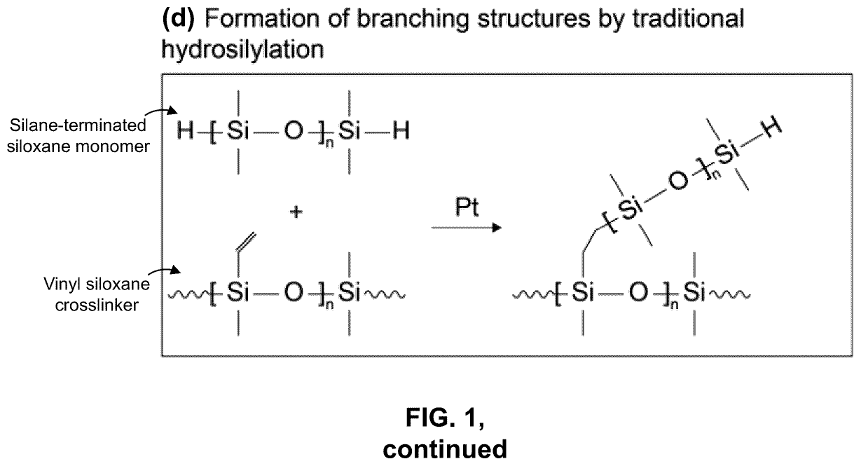

FIG. 1 illustrate a mechanism of peroxide-induced polymerization of siloxane monomers. Part (a) illustrates the hydrogen abstraction of a silane-terminated siloxane monomer by a catalyst Pt to generate a siloxyl radical. The hydrogen abstraction may occur in the sole presence of water (H₂O) and oxygen (O₂), such as during ambient conditions including ambient humidity, however, the reaction proceeds slowly, for example up to 48 hours. The hydrogen abstraction reaction is accelerated in the presence of a peroxide initiator (i.e., a radical initiator).

Part (b) illustrates the oxidation of a methyl group to form a carbon radical. Part (c) illustrates the formation of branching structures by coupling of carbon radicals formed in part (b) and the silyl or siloxyl radicals formed in part (a). Steps in part (b) and part (c) may be limiting following acceleration of the reaction in part (a). In one approach, the reliance on the reaction of part (c) for crosslinking may be mitigated by introducing small amounts of a vinyl crosslinker as shown in part (d) before the reaction of part (c). The introduction of a vinyl crosslinker may avoid preliminatry curing by a traditional hydrosilylation reaction. Part (d) illustrates the formation of branching structures by the combination of silane-terminated siloxane monomers and vinyl-functionalized siloxane monomers by traditional hydrosilylation.

In various embodiments, methodology as described herein may be extended to create recipes for a specific product that is formed by photopolymerization curing. In some approaches, properties (e.g., physical properties, mechanical properties, etc.) of the formed material may be tuned according to the formulation of components. In one exemplary approach, a product formulation may include silane-terminated silicones, a platinum catalyst, and a peroxide-based initiator (e.g., a radical initiator) for photopolymerization. This product formulation may be used in the manufacture of medical devices, in processes related to photolithography, in three-dimensional (3D) printing applications, and/or in other areas where photopolymerization of silicones is relevant.

As described herein, an addition of radical initiators and inhibitors that are common for radical-based polymerization may be used to influence the rate of reaction of the hydride-terminated siloxane monomers (e.g., silane-terminated siloxane monomers, silane-pendant siloxane monomers, multi-silane siloxane monomers, etc.). In some approaches, the hydride-terminated siloxane monomer is a macromer being a high molecular weight macromolecule with a single functional polymerizable group. In various approaches, hydride-terminated siloxane monomers may have an average molecular weight (MW) in a range between 1,000 and 100,000 gram/mol (g/mol).

Furthermore, the radical-based polymerization reaction may be orthogonal to a hydrosilylation reaction, so vinyl functionalized macromers may be added to modify properties to make highly stretchable polysiloxanes (e.g., >1000% strain), ultrasoft polysiloxanes, and other polysiloxanes with targeted mechanical properties. In preferred approaches, vinyl functionalized macromers may be added simultaneously in the composition as the hydride-terminated macromers. The respective reactions may proceed in either order. For example, photooxidation may be initiated first, and hydrosilylation is inhibited so that it occurs after photooxidation. Alternatively, conditions may be tuned so that the hydrosilylation reaction occurs first, followed by thermal oxidation and/or photooxidation.

In various approaches, the composition includes silicones (e.g., siloxanes) that may contain one or more silane functional groups. Silicones may be linear polymers, branched polymers, larger structures (e.g., resins), etc. Hydride-terminated siloxane monomers may be various forms including linear hydride-terminated siloxane monomer, a branched hydride-terminated siloxane monomer, a multifunctional hydride-terminated siloxane monomer, etc. The silane functional group may be pendant on the polymer. The silane functional group may be terminal on the polymer.

TABLE 1
Examples of components

| | Photoactivated | Thermally-activated | |
|---|---|---|---|
| Silicones | initiators | Initiators | Photosensitizers |
| DMS-H41¹ | Acetophenone | 2-2′- | Pyrene |
| | | Azobisisobutyronitrile | |
| DMS-H25¹ | Anthraquinone | Benzoyl peroxide | Perylene |
| MCR-H22¹ | Benzil | Lauroyl peroxide | Naphthalene |
| DMS-HXX² + | Benzophenone | 1,1-Bis(tert- | Anthracene |
| VDT-731¹ | | butylperoxy)-3,3,5- | |
| | | trimethlcyclohexane⁴ | |
| DMS-HXX + | 2-Chlorothioxanthen-9- | Methyl acrylate | Fluorene |
| MQV¹ | one | | |
| Sylgard ™ 184³ | 2,2- | Methyl methacrylate | Biphenyl |
| | Diethoxyacetophenone | | |
| HMS-031¹ | 2,2-Dimethoxy-2- | | Phenanthrene |
| | phenylacetophenone | | |
| | 2-Hydroxy-2- | | 2,5- |
| | methylpropiophenone | | Diphenyloxazole |
| | Thioxanthen-9-one | | m-Terphenyl |

¹Gelest, Morrisville, PA
²DMS-HXX refers to any number from Gelest (e.g., DMS-H41, DMS-H25, etc.)
³Dow Chemical Company, Midland, MI
⁴Luperox ® 231, Arkema, Inc., Torrance, CA

Table 1 lists examples of each component of the composition, and lists examples of silicones, such as hydride terminated polydimethylsiloxane (PDMS), (10,000 cSt) (DMS-H41, Gelest, Morrisville, PA), hydride terminated polydimethylsiloxane, (500 cSt) (DMS-H25, Gelest), monohydride terminated polydimethylsiloxane, asymmetric, (150-250 cSt) (HCR-H22, Gelest), methylhydrosiloxane-dimethylsiloxane copolymer, trimethylsiloxane terminated (25-35 cSt) (HMS-031), polydimethylsiloxane, etc. These are by way of example only, and are not meant to be limiting in any way. In some approaches, the composition may include combinations of different hydride-terminated siloxane monomers. For example, the composition may include a combination of monomers, macromers, etc. In preferred approaches, the hydride-terminated siloxane monomers include multisilane siloxane monomers, for example, branched silane-terminated siloxane monomers, multisilane crosslinkers, silane-terminated resins, organofunctional silanes, etc.

In some approaches, the composition may include a vinyl functionalized siloxane (e.g., a vinyl siloxane monomer) that accelerates the curing process. The presence of vinyl siloxane monomers in the composition may result in different material properties of the cured material. For example, with increasing amounts of vinyl siloxane monomer, the cured material has increased stiffness. The vinyl functional group may be at a terminal position. The vinyl functional group may be pendant on the polymer. Moreover, the presence of vinyl siloxane monomers in the formulation affects the curing kinetics, such as accelerating the curing reaction. In some approaches, the vinyl siloxane monomer may be a multifunctional vinyl siloxane monomer. In various approaches, the average molecular weight of the vinyl siloxane monomer may be in a range of about 1,000 to about 150,000 g/mol. The amount of vinyl-functionalized siloxane monomer in the formulation may range from greater than 0 to an equivalent amount of hydride-terminated siloxane monomer.

In conventional resins for forming a siloxane elastomer (e.g., rubber), siloxane monomers may have functional groups such as thiols instead of hydrides or vinyls groups. A disadvantage of using siloxane monomers having thiol functional groups is the thiols are odorous having a strong odor resembling garlic or rotten eggs. Thus, in some applications, use of siloxane monomers with thiol groups is not preferred. As described herein, formation of a siloxane elastomer includes a resin comprising hydride-terminated siloxane and in some approaches, a combination of hydride-terminated siloxane monomers and vinyl-terminated siloxane monomers. The composition is essentially free of odors, especially odors typically associated with thiols which are not present.

In one example, a formulation includes a hydride terminated macromer in the presence of various combinations of a platinum catalyst and a radical initiator. The polysiloxane may be a linear polysiloxane terminated by silane (i.e., hydrogen). In various approaches, silane-terminated siloxane monomer, including silane-terminated polysiloxanes, include branched silanes, multifunctional silanes, silane-based resins, etc.

The composition preferably includes a catalyst that abstracts hydrogen from the silicon atom of the silane group of the polysiloxane for initiating the reaction with a reactive silicone atom. In some approaches, the catalyst is a hydrosilylation catalyst. In a preferred approach, the hydrosilylation catalyst is a platinum (Pt) catalyst for initiating the reaction. The Pt catalyst may be obtained commercially, e.g., Karstedt's catalyst, Ashby's catalyst, etc. In other approaches, the catalyst may be a metal catalyst such as rhodium, iridium, ruthenium, etc.

For light-based curing, a composition includes components for initiating and controlling the curing reaction. In one approach, a composition includes a photoactivated initiator for generating radicals in response to light. In one approach, a composition may include a photosensitizing agent in addition to the photoactivated initiator. In another approach, a composition may include a combination of a thermally activated initiator and a photoactivated initiator. In one approach, a composition may include a radical inhibitor such as a photo absorbing material, that absorbs light. In an exemplary approach, a composition designed for light-based curing may include a thermally activated initiator for further accelerating the curing reaction initiated by a photoactivated imitator.

In various approaches, the radical initiator includes a photoactivated initiator. In some approaches, a photoactivated initiator may be referred to as a sensitizer (e.g., an accelerant) for boosting the rate of a peroxide-based crosslinking reaction. As listed in Table 1, the photoactivated initiator may include acetophenone, anthraquinone, benzil, benzophenone, 2-chlorothioxanthen-9-one (CTAO), 2,2-diethoxyacetophenone, 2,2-dimethoxy-2-phenylacetophenone (DMPA), 2-hydroxy-2-phenylacetophenone, 2-hydroxy-2-methylpropiophenone, thioxanthen-9-one, 3,4-dimethoxyacetophenone, 2,4,6-trimethylbenzoyldiphenylphosphinate (TPO-L), etc. In some approaches, photoactivated initiators may include monoketals, α-diketones, α-ketoaldehydes, acyloins, acyloin-corresponding ethers, etc. These examples are not meant to be limiting in any way, and further examples may include photoactivated initiators otherwise not mentioned herein.

In some approaches, a photoactivated initiator may function sufficiently as a photosensitizing agent so no additional photosensitizing agent may be needed in the composition. For example, DMPA functions as both a photoactivated initiator and a photosensitizing agent. Alternatively, a composition that includes the photoactivated initiator benzophenone preferably also includes a photosensitizing agent.

In various approaches, an amount of photoactivated initiator may be in a range of greater than about 0.1 wt. % to 5.0 wt. % of the weight of the siloxane monomer. In some approaches, the amount of photoactivated initiator is relative to the weight of the composition, such as the total weight of siloxane monomers (hydride-terminated siloxane monomers, vinyl-terminated siloxane monomers, etc.) Preferably, an amount of photoactivated initiator may be in a range of greater than 0.1 wt. % to 1 wt. % for optimal solubility in the siloxane monomer with complete curing.

In some approaches, a photoactivated initiator may also act as a photosensitizer (e.g., a photosensitizing agent) in the presence of the thermally activated initiator. In some approaches, a photosensitizing agent (e.g., sensitizers) may be included with a co-initiating species (e.g., a photoactivated initiator, a thermally activated initiator, etc.) to facilitate the formation of radicals with another co-initiating species and can often promote faster polymerization speeds under mild irradiation than compositions without sensitizers. In some approaches, a photosensitizing agent may be used to make a resin reactive when exposed to light at another wavelength of interest, such as 385 or 405 nm lamps that are common in some light directed AM apparatuses, e.g., SLA printers.

In various approaches, the composition includes a photosensitizing agent. A photosensitizing agent may be traditional dyes having aromatic units that absorb light between 420 nm to 280 nm. For example, as listed in Table 1, a photosensitizing agent may include at least one of the following: 2-chlorothioxanthone, 2,5-diphenyloxazole, pyrene, perylene, naphthalene, diispropylnapthalene (DIPN), anthracene, fluorene, biphenyl, phenanthrene, m-terphenyl, etc. 2-chlorothioxanthone may function as both a photoactivated initiator and a photosensitizing agent, the function may depend on the other components of the composition. These examples are not meant to be limiting in any way, and further examples may include photosensitizing agents otherwise not mentioned herein.

For some compositions, an amount of photosensitizing agent may be in a range of greater than 0 to 5 wt. % of the total weight of the siloxane monomer (e.g., silane-terminated polysiloxane). In some approaches, the amount of photosensitizing agent is relative to the total weight of the composition. Preferably, the amount of added photosensitizing agent is equivalent to the amount of photoactivated initiator present in the composition. An amount of photosensitizing agent greater than 5 wt. % of the polysiloxane may accelerate the curing reaction, however, the excess components, such as the photoactivated initiator, thermally activated initiator, radical inhibitor etc., may have a detrimental effect on the mechanical properties of the material. For example, the non-polysiloxane additive components may collect in pockets of the cured material.

For thermal-based curing, a composition includes a thermally activated initiator. In some approaches, as listed in Table 1, a thermally activated initiator may include Luperox® 231 (1,1,Bis(tert-butylperoxy)-3,3,5-trimethylcyclohexane) (Arkema, Inc., Torrance, CA), 2,2-azobisisobutyronitrile, benzoyl peroxide, lauroyl peroxide, methyl acrylate, methyl methacrylate, etc. These examples are not meant to be limiting in any way, and further examples may include thermally activated initiators otherwise not mentioned herein.

In various approaches, an amount of thermally activated initiator in the composition may be in a range of greater than 0 to 10 wt. % of the siloxane monomer. Preferably, the amount of thermally activated initiator is in a range of greater than 1 to about 5 wt. % of the siloxane monomer.

In some approaches, the radical initiator of the composition includes a thermally activated initiator. In a preferred approach, the radical initiator of a composition for photo-based curing includes a thermally activated initiator and a photoactivated initiator. The temperature of the curing reaction is preferably room temperature. Without wishing to be bound by any theory, the presence of a thermally activated initiator in the composition may at least function to disperse the additive materials (e.g., photoactivated initiator, photosensitizing agent, radical inhibitor, etc.) in the polysiloxane composition and accelerate the curing reaction at room temperature. For compositions for photo-based curing, an amount of thermally activated initiator may be in a range of greater than 0 to about 5 wt. % but may be higher to 10 wt. % of the total weight of the composition.

Radical initiators may also be quenched by inhibitors, such as radical inhibitors, photoabsorbers, etc. For some hydrosilylation compositions, excess amounts of hydride functional polysiloxane are used. These excess hydrides could potentially react in the same way described previously in this report. This reaction may be unideal for applications where compression set can be of concern; the crosslinking of excess hydrides would increase the value of compression set. Thus, the addition of a radical inhibitor may be useful for preventing a compression set by this mechanism.

In some approaches, a radical inhibitor may be used that absorbs light between a different range of wavelengths that may be used for curing. In some approaches, an amount of inhibitor may be in a range of 0.05 wt. % to about 0.5 wt. % of total weight of the composition. Examples of inhibitors that may be used in the composition include: butylated hydroxytoluene, 4-methoxyphenol, hydroquinone, coumarins, etc.

In various approaches, a composition includes a catalyst being a hydrosilylation catalyst. The hydrosilylation catalyst includes one of the following metals: platinum, rhodium, iridium, and ruthenium. In preferred approaches, the hydrosilylation catalyst is Karstedt's catalyst, i.e., a Pt-based catalyst.

The amount of hydrosilylation catalyst may be in the range of about 5 ppm to 500 ppm of the composition. For example, the amount of Karstedt's catalyst may be in the range of about 5 ppm Pt to about 500 ppm Pt of the composition. In some approaches, peroxides may be included to impact hydrosilylation, however, peroxides have not been used for compositions where the primary crosslinking mechanism involves the coupling of hydride terminated siloxanes without vinyl-terminated siloxanes. As described herein, including a radical initiator in the composition having a silane-terminated siloxane and a hydrosilylation catalyst will allow for rapid, orthogonal curing chemistries that can affect the network of the material and the material properties.

In various approaches, the curing reaction in ambient air and relative humidity may be accelerated with increased humidity (e.g., increased presence of water in the reaction). In various approaches, relative humidity may approach 100%. As disclosed in prior reports, the oxygen in ambient air may contribute to the curing reaction.

In one preferred approach, a composition of the composition includes a hydride-terminated polysiloxane, a platinum catalyst, and a radical initiator that generates radicals (e.g., Luperox L-231). The content of the radical initiator affects the curing time; more radical initiator cures more quickly.

In some approaches, a formulation of the composition may include small molecules for adjusting the viscosity of the resin, ink, etc. that are soluble in one or more siloxane monomers. In some approaches, the resin may include silica, binder, etc.

In some approaches, a formulation of the composition may include radical inhibitor, photoabsorber, photoinhibitor, etc. depending on the wavelength of light being used for light-directed AM and/or curing.

In some approaches, the composition may include an additive, such as a photopolymerization inhibitor, e.g., a photoabsorber. With some photoactive resins used in light-directed 3D printing, polymerization may propagate outside the intended projection area, thereby decreasing part resolution as well as potentially creating inhomogeneities in the resin bath (and subsequently the printed part) as resin becomes partially polymerized. This may be prevented by including various additives in the resin composition. In some approaches, the additive may include various types of photoinhibitors. In one approach, one type of photoinhibitor, e.g., a UV blocker, absorbs stray photons and limits spread and penetration depth of light into resin, thereby minimizing photoinitiation outside of the intended projection area. In another approach, another type of photoinhibitor causes chemical quenching, where compounds actively quench or terminate polymerization reactions.

A potential application for this curing mechanism could be to form elastomers where the composition has low viscosity in the uncured state and can easily fill a mold. The uncured composition may contain hydride functionality on the polymer backbone or on the terminal ends of the polymers, and the composition may also contain vinyl functionality in the same way.

The composition may also contain other macromers, functional siloxanes, or silica. With the addition of silica, the composition could be used for additive manufacturing, which would benefit from the orthogonal curing of hydrosilylation and peroxide-initiated coupling of the hydride groups. Orthogonal curing may be defined as there may be distinct reaction occurring in the composition in addition to the curing reaction. In one approach, in one composition, one reaction occurs according to a thermal time scale, and a second reaction occurs according to a photo-curing based time scale. The time scale for each rection may be different. In conventional curing reactions of polysiloxanes, a coupling reaction occurs simultaneously with the curing reaction. As described herein, the coupling reaction of the siloxane monomers may occur at a different time using a different mechanism as the curing reaction in the same composition.

In one approach, the composition is a resin for forming a structure using a stereolithography additive manufacturing technique. In another approach, the composition is an ink for forming a structure using a direct ink writing additive manufacturing technique.

A fast hydrosilylation reaction with the addition of photoactivated initiators may improve the fidelity of printed parts and a fast crosslinking reaction ensures that these parts maintain their final shape. The composition may also use other catalysts that are less efficient for crosslinking but could be useful for chain extension or other modifications to the hydride-functional polysiloxane.

For example, in one composition, silane-terminated siloxanes and vinyl-terminated siloxanes may be combined to a long, single stranded polymer using a thermal-based coupling reaction, and then a second reaction being a photo-based curing reaction causes the polymers to cure into a material having specific mechanical properties.

### A Curing Accelerator

In one embodiment, a curing accelerator may be added to a thermal-curable siloxane resin for converting the resin to a radiation-curable siloxane resin. In one approach, the curing accelerator includes a photoactivated initiator and a photosensitizing agent. In another approach, the curing accelerator includes photoactivated initiator and a thermally activated initiator. In yet another approach, the curing accelerator includes a photoactivated initiator, a photosensitizing agent, and a thermally activated initiator.

In some approaches, a curing accelerator is a catalyst/initiator mixture and includes a catalyst, a photoactivated initiator, and a thermally activated initiator. In one approach, the curing accelerator may include a catalyst, a photoactivated initiator, a photosensitizing agent, and a thermally activated initiator.

According to one embodiment, the curing accelerator mixture may be used for converting a polysiloxane resin from a thermal-curable polysiloxane to a photo-curable polysiloxane, where the polysiloxane resin is purchased commercially. The accelerator would serve as a kit to convert from thermal cure to photo (i.e., UV) cure. A curing accelerator mixture may be engineered to switch the mechanism from thermally activated initiated curing mechanism to a radiation-initiated curing mechanism of siloxane monomers.

In one example, a conventional two-part silicone thermal curing molding resin that includes a hydrosilylation catalyst (e.g., Sylgard™ 184 silicone) may be converted to a photo-curable resin by adding a radical initiator mixture of photoactivated initiator/thermally activated initiator/photosensitizing agent, such that the resin+initiator mixture may be cured by exposure to UV light at room temperature.

### Method of Forming a 3D Structure

According to one embodiment, a composition includes a radical initiator in the presence of a hydride-terminated polysiloxane to increase the rate of curing of the composition to form a siloxane elastomer material. In one approach, the composition is a product for the use of additive manufacturing processes. For example, the product is a resin for stereolithography techniques. In another example, the product is an ink for extrusion processes using direct ink writing.

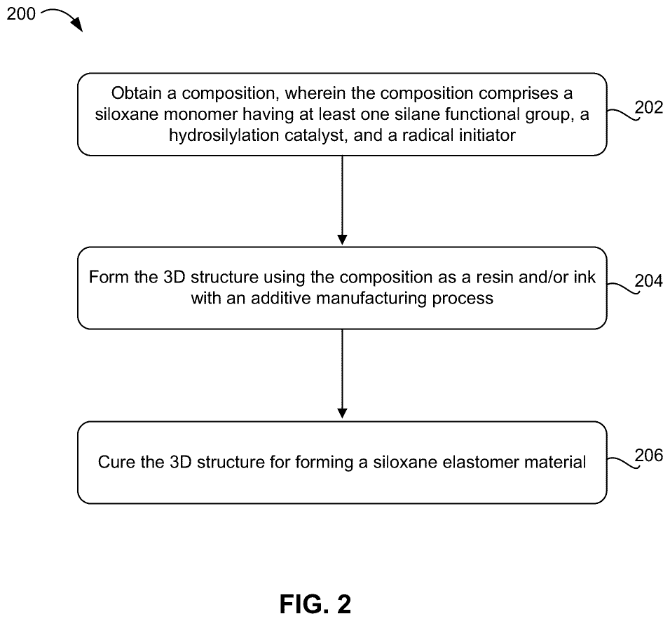

FIG. 2 shows flowchart for a method 200 for forming a three-dimensional (3D) structure, in accordance with one inventive aspect. As an option, the present method 200 may be implemented to construct structures such as those shown in the other FIGS. described herein. Of course, however, this method 200 and others presented herein may be used to form structures for a wide variety of devices and/or purposes which may or may not be related to the illustrative inventive aspects listed herein. Further, the methods presented herein may be carried out in any desired environment. Moreover, more, or less steps than those shown in FIG. 2 may be included in method 200, according to various inventive aspects. It should also be noted that any of the aforementioned features may be used in any of the inventive aspects described in accordance with the various methods.

Operation 202 includes obtaining a composition where the composition includes a siloxane monomer having at least one silane functional group, a radical initiator, and a hydrosilylation catalyst. The composition does not include a solvent. The composition includes components as described herein.

Operation 204 includes forming the 3D structure using the composition as a resin and/or ink with an additive manufacturing process. In various approaches, silicone elastomer products may be fabricated using 3D printers using UV light to cure resins in a layer-by-layer fashion. In one approach, a 3D printer may be a stereolithography (SLA) type printer that uses a rastered UV laser. In another approach, the 3D printer may be a digital light processing (DLP) type printer that uses a projected mask with a UV light.

In another approach, the silicone elastomer 3D structure may be fabricated using a direct ink writing (DIW) technique where the composition as described herein as used an ink to be extruded through a nozzle. The formed 3D structure may be cured by radiation-initiated curing. Alternatively, in one approach, each extruded layer may be exposed to UV irradiation to cure the extruded layers in a layer-by-layer process.

In some approaches, the 3D structure is self-supporting prior to curing. The 3D structure formed using the composition as ink, resin, etc. includes self-supporting walls arranged in a pre-defined pattern. In some approaches, the formulation of the composition may be designed to be sufficiently mechanically robust for self-supporting complex architectures. Moreover, the formulation allows formation of a mechanically stable structure having an aspect ratio capable of supporting its own weight, e.g., a self-supporting structure, prior to curing.

Operation 206 includes curing the formed 3D structure for forming a siloxane elastomer material. In one approach, the curing may include exposing the composition to light for polymerizing the composition to form a structure having a siloxane elastomer material. In one approach, the composition is warmed to room temperature to initiate polymerization of the composition. In another approach, the curing includes heating to initiate thermal curing of the composition. The duration of the curing may depend on several factors such as the size of the sample, the radical initiator, the intensity of the light, etc.

In some approaches, operations 204 and 206 of forming a 3D structure and curing the formed 3D structure may occur simultaneously. For example, a projection micro-stereolithography (PμSL) technique uses a light to form the 3D structure according to a predefined pattern where the resin is cured upon exposure to the light.

In one approach, the radical initiator of the composition includes a photoactivated initiator and a thermally activated initiator. In another approach, the radical initiator of the composition includes a photoactivated initiator, a photosensitizing agent, and thermally activated initiator.

In various approaches, the temperature of the curing may be in a range of room temperature up to 90° C. In one approach, temperature of the photo-based curing reaction of the composition may be in the range of room temperature up to 90° C. Most printers for additive manufacturing are used at 60° C.

The method 200 as shown in FIG. 2 of forming a 3D structure is highly scalable and compatible with additive manufacturing (e.g., light-based 3D printing methods such as digital light processing, PμSL, etc.). In various approaches, the product has physical characteristics of formation by an additive manufacturing technique. In various approaches, physical characteristics may include filaments arranged in a geometric pattern, a patterned outer surface defined by stacking filaments, etc. Thus, using these additive manufacturing techniques allows engineering of parts and production of optimal geometry for efficient radiation detection and mechanical strength.

In a preferred approach, the composition may be exposed to the light during performance of an additive manufacturing technique that uses the composition as a resin for formation of a three-dimensional structure having a geometric pattern. This composition may be cured using a light defined by the radical initiator, for example using a light having a wavelength in a range of 420 nm to 280 nm. Application of the light may include shining the light using a separate lamp, an additive manufacturing apparatus incorporating such a lamp, a laser at a similar wavelength, etc.

Rapid light-induced polymerization of a polysiloxane resin composition allows printing of structures having precise, fine features, e.g., filaments, ligaments, etc.

In some approaches, the rapid curing of radical-mediated polymerization may allow a print image of a building part to be changed between layers, allowing for non-monolithic print geometry. For example, a part may be built in a bath of uncured resin. For each layer, the light is specifically focused on a 2D projection plane where the resin exposed to UV light is cured. The part then is moved away from the projection plane, recoated with resin, brought back to the image plane within the bath, and cured. This process allows the next layer to be cured on the same plane, thus enabling the print image to be changed between layers. This process thereby forms a product having a non-monolithic geometry.

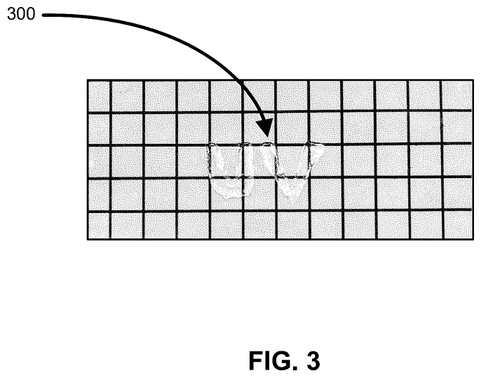

In one example of an approach, a three-dimensional structure 300 is formed using a composition as described herein in an additive manufacturing technique, as shown in the image of FIG. 3. The structure 300 was formed using a composition that included a silane-terminated polysiloxane, a thermally activated initiator (L231) and a photoactivated initiator (DMPA). It was cured by shining UV light through a shadow mask for a period of about 15 minutes. The three-dimensional structure 300 is transparent and formed according to a pre-defined pattern (e.g., the letters U V).

### Experiments

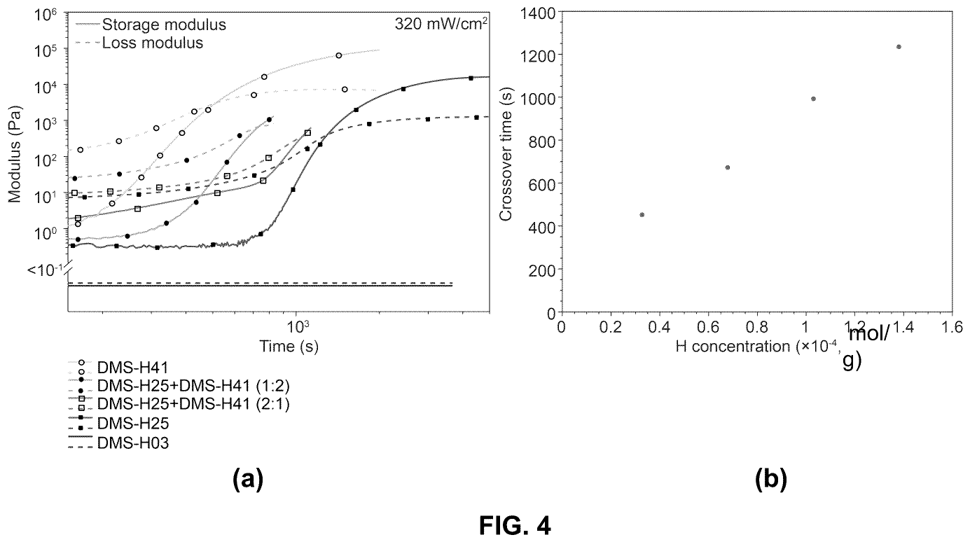

FIG. 4 part (a) is a plot of the curing kinetics in terms of storage modulus (dashed lines) and loss modulus (solid lines) over time of compositions comprising different siloxane monomers. The plot demonstrates that the hydrogen concentration of the formulation may affect curing. Specifically, the relative ratio of the hydrogen concentration to the platinum concentration is a key parameter to control the reaction kinetics. The viscosity of the siloxane monomer may also affect the curing. A composition that includes hydride-terminated polydimethylsiloxane (2-3 cSt) (DMS-H25, Gelest) (lines with no symbols) showed no change in storage or loss modulus after about 1 hour of UV light exposure. The other siloxanes demonstrated a change in storage modulus and loss modulus over 1000 seconds (about 16 minutes) and the time of the crossover of the storage modulus with the loss modulus indicating the cure time. The hydride terminated PDMS (10,000 cSt) (DMS-H41, Gelest) (○) demonstrated the quickest cure time, followed by a combination of hydride terminated PDMS at 2 of 10,000 cSt to 1 of 500 cSt (DMS H25, Gelest) (●). Increasing the amount of 500 cSt hydride terminated PDMS to 10,000 cSt. hydride terminated PDMS (□) delayed the cure time further, and the composition including only the 500 cSt hydride terminated PDMS (▪) had the most delayed cure time at around 20 minutes.

Part (b) of FIG. 4 is a plot of the concentration of hydrogen (H) at the different crossover times (storage modulus vs loss modulus) measured in part (a). The composition having the slowest curing time had the highest concentration of hydrogen, and conversely, the composition having the fastest curing time had the lowest concentration of hydrogen. The relative amount of hydrogen per gram of formulation demonstrates an effect on the curing kinetics. Specifically, the amount of Pt relative to the amount of hydrogen influences the curing kinetics. As the amount of Pt relative to hydrogen increases, the hydrogen abstraction due to Pt may occur more quickly, accelerating the curing.

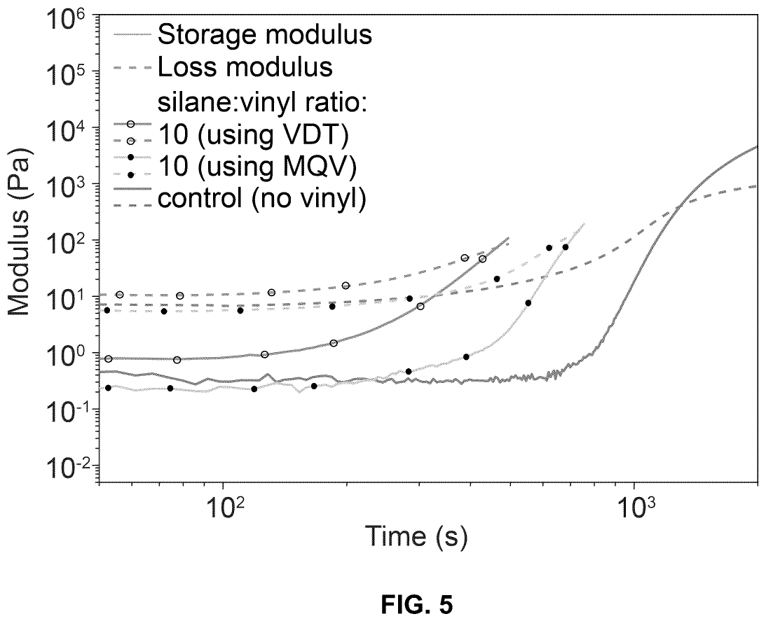

FIG. 5 depicts a plot of the curing kinetics of a composition including silane-terminated siloxane monomer and a vinyl-functionalized siloxane monomer (VDT-731, trimethylsilyl treated silicate with reactive vinyl group (MQV), etc.). The composition comprising only a silane-terminated siloxane monomer (no vinyl functionalized siloxane monomer) (no symbols) demonstrated the longest cure time, depicted by the crossover of storage modulus and loss modulus just under 20 minutes. The addition of the vinyl-functionalized siloxane monomer (MQV) (●) shortened the curing time to 725 seconds, and the addition of the vinyl-functionalized siloxane monomer (VDT) (○) shortened the curing time to 460 seconds. Including a vinyl-functionalized siloxane with the silane-terminated siloxane monomer in the composition accelerates the curing time of the composition.

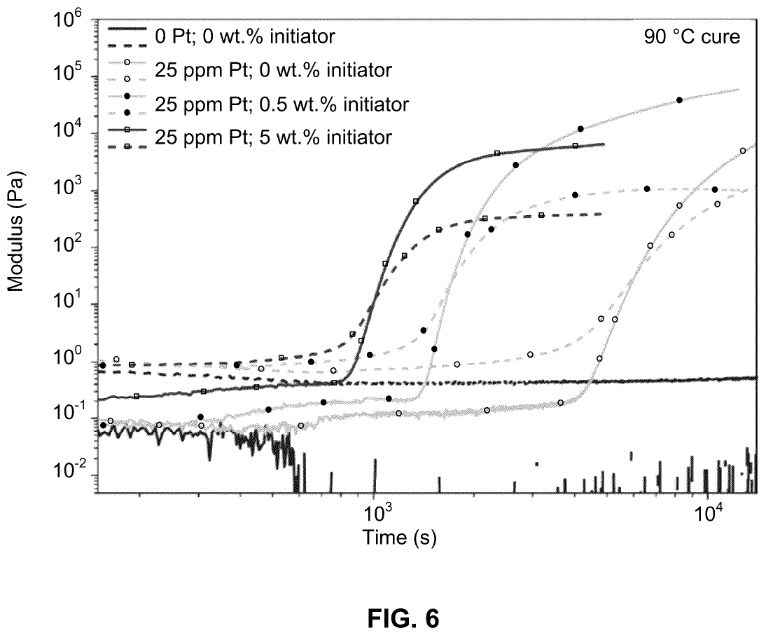

As illustrated in FIG. 6, the curing kinetics of the composition demonstrated that an increase in the content of the radical initiator, such as demonstrated here with a thermally activated initiator, (from 0 wt. % to 0.5 wt. % to 5.0 wt. %) (e.g., L-231), increased the rate of reaction as monitored by oscillatory rheological measurements of the composition at 90° C. Each sample included a different concentration of thermally activated initiator in the presence of a Pt catalyst at 25 ppm. The point at which the storage modulus (solid line) exceeded the loss modulus (dashed line) was used as an indication of curing. This crossover point shifted from 104 minutes with 0 wt. % initiator (○) to 34 minutes with 0.5 wt. % initiator (●) to 24 minutes with 5 wt. % initiator (□). Without platinum catalyst, the reaction did not proceed (black solid/dashed line without symbols). As the thermally activated initiator increased in concentration, the reaction proceeded more quickly, e.g., comparing 0.5 wt. % initiator (●) to 5.0 wt. % initiator (□).

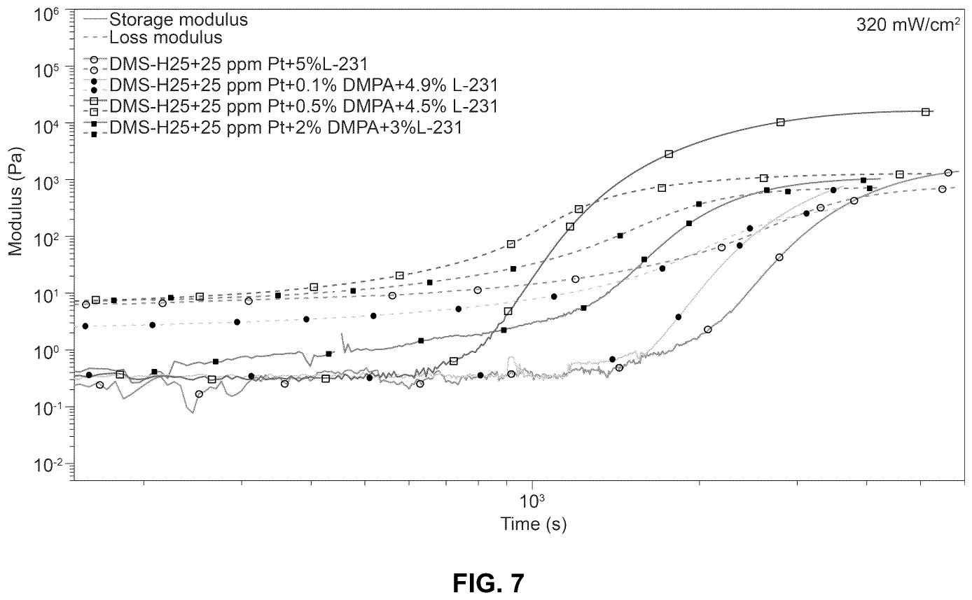

FIG. 7 is a plot of the curing kinetics of compositions having a thermally activated initiator (L-231) and a photoactivated initiator (DMPA). Each composition included hydride terminated PDMS (500 cSt) (DMS-H25, Gelest) and 25 ppm Pt catalyst. The fastest cure (e.g., most accelerated) occurred with the composition having a concentration of photoactivated initiator at 0.5 wt. % and thermally activated initiator at 4.5 wt. % (□). Increasing the concentration of photoactivated initiator to 2 wt. % with thermally activated initiator at 3 wt. % (▪) delayed the cure time, and reducing the photoactivated initiator to 0.1% with increased thermally activated initiator (●) was similar to the composition having only thermally activated initiator at 5 wt. % (○).

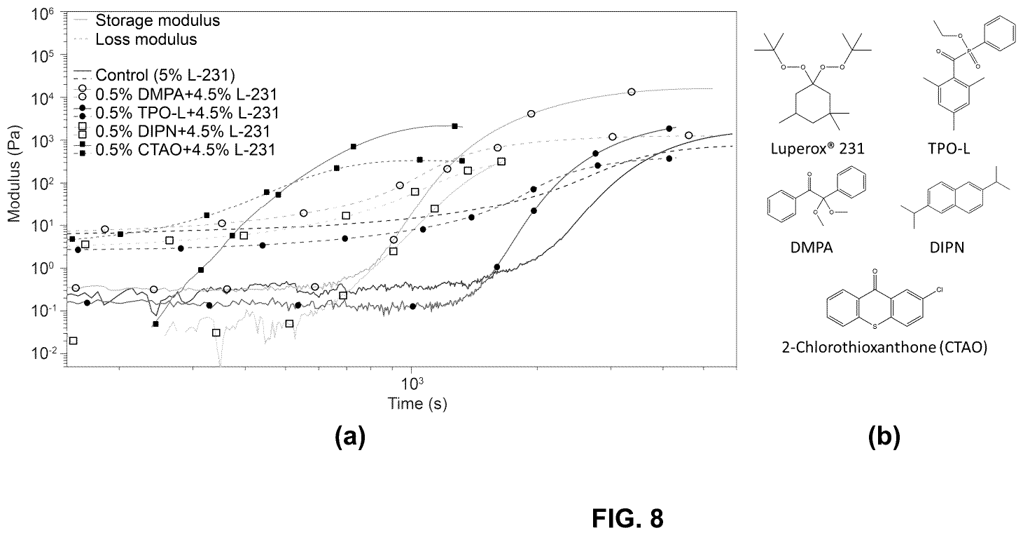

FIG. 8 depicts the curing kinetics (in part (a)) of compositions having 4.5 wt. % thermally activated initiator (L-231) with different photoactivated initiators (the structures depicted in part (b)). The composition without any photoactivated initiator (no symbols) demonstrated the slowest curing. Of the photoactivated initiators assessed, the composition having CTAO (▪) demonstrated the most accelerated cure, the compositions with DMPA (○) and DIPN (□) had comparable cure times, and the composition with TPO-L (●) cured at a much slower rate, but faster than the composition without any photoactivated initiator (no symbols).

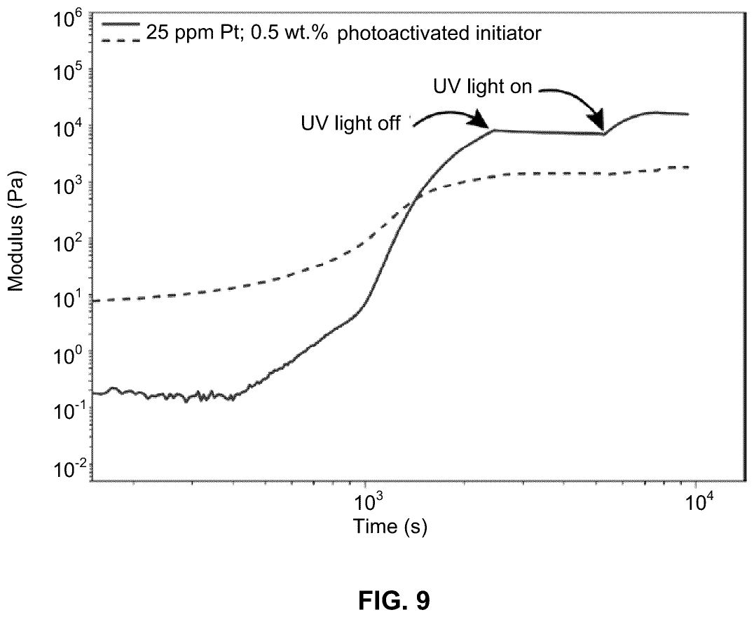

In addition to having a thermally initiated initiator present (e.g., thermally initiated peroxides), a photoactivated initiator peroxide may be included in the composition. As illustrated in FIG. 9, a photoactivated initiator peroxide was used at 0.5 wt. % in a hydride-terminated polysiloxane along with 25 ppm of platinum. The photoinitiated curing of hydride-terminated polysiloxane was carried out at room temperature. After about 23 minutes at room temperature, the storage modulus (solid line) exceeded the loss modulus (dashed line). To further demonstrate control of curing, the UV source was turned off after about 40 minutes of being cured. At this point, the storage modulus plateaued. After turning the lamp on again, the storage modulus began increasing again.

In one approach, a silicone resin having a photoactivated initiator is activated by exposure to light, and without exposure to light, (e.g., light is turned off), the silicone resin is not activated and the curing reaction does not deactivate. The curing reaction during exposure to light is immediate and is not reversible. Thus, without the described tuning of the reaction, conventional systems have a detrimental ability of having the entire resin cured because the catalyst does not deactivate after the light is turned off, and resolution of the printed part is lost. This selectivity in the UV curing is critically important for additive manufacturing by vat photopolymerization. Therefore, compositions that use this reaction mechanism could be useful for printing elastomers with controlled mechanical properties.

### In Use

Various inventive aspects described herein may be used for polysiloxane and silicone curing, such as elastomer material, rubbers, foams, etc. Various inventive aspects of polysiloxane curing may be useful for additive manufacturing, such as direct ink writing, vat photopolymerization, etc. Moreover, inventive aspects may include uses of polysiloxane curing as described herein for photolithography.

The inventive aspects disclosed herein have been presented by way of example to illustrate the myriad features thereof in a plurality of illustrative scenarios, aspects of an inventive aspect, and/or implementations. It should be appreciated that the aspects generally disclosed are to be considered as modular, and may be implemented in any combination, permutation, or synthesis thereof. In addition, any modification, alteration, or equivalent of the presently disclosed features, functions, and aspects that would be appreciated by a person having ordinary skill in the art upon reading the instant descriptions should also be considered within the scope of this disclosure.

While various aspects of an inventive aspect have been described above, it should be understood that they have been presented by way of example only, and not limitation. Thus, the breadth and scope of an aspect of an inventive aspect of the present invention should not be limited by any of the above-described exemplary aspects of an inventive aspect but should be defined only in accordance with the following claims and their equivalents.

What is claimed is:

1. A composition for forming a siloxane elastomer material, the composition comprising:
a siloxane monomer having at least one silane functional group;
a hydrosilylation catalyst; and
a radical initiator.

2. The composition as recited in claim 1, wherein the siloxane monomer is selected from the group consisting of: a linear hydride-terminated siloxane monomer, a branched hydride-terminated siloxane monomer, a multifunctional hydride-terminated siloxane monomer, and a combination thereof.

3. The composition as recited in claim 1, wherein the siloxane monomer comprises a silane-terminated siloxane monomer.

4. The composition as recited in claim 1, further comprising a vinyl-functionalized siloxane monomer.

5. The composition as recited in claim 1, wherein the radical initiator comprises a thermally activated initiator.

6. The composition as recited in claim 5, wherein an amount of the thermally activated initiator is in a range of greater than 0 to about 10 weight % of a total weight of the composition.

7. The composition as recited in claim 1, wherein the radical initiator comprises a photoactivated initiator.

8. The composition as recited in claim 7, wherein an amount of the photoactivated initiator is in a range of greater than 0 to about 5.0 weight % of a total weight of the composition.

9. The composition as recited in claim 7, wherein an amount of the photoactivated initiator is in a range of greater than 0.1 weight % to about 1.0 weight % of a total weight of the composition.

10. The composition as recited in claim 7, wherein the radical initiator includes a photosensitizing agent.

11. The composition as recited in claim 10, wherein an amount of the photosensitizing agent by weight is about equivalent to an amount of the photoactivated initiator.

12. The composition as recited in claim 1, wherein the radical initiator comprises a combination of a thermally activated initiator and a photoactivated initiator.

13. The composition as recited in claim 1, wherein the hydrosilylation catalyst is a metal-based catalyst having a metal selected from the group consisting of:
platinum, rhodium, iridium, and ruthenium.

14. The composition as recited in claim 1, wherein the composition is a resin for forming a structure using a stereolithography additive manufacturing technique.

15. The composition as recited in claim 1, wherein the composition is an ink for forming a structure using a direct ink writing additive manufacturing technique.

16. A curing accelerator for converting a thermal-curable siloxane resin to a radiation-curable siloxane resin, the curing accelerator comprising:
a radical initiator; and
a photosensitizing agent.

17. The curing accelerator as recited in claim 16, wherein the radical initiator comprises a photoactivated initiator and/or a thermally activated initiator.

18. A method of forming a three-dimensional (3D) structure, the method comprising:
obtaining a composition, wherein the composition comprises a siloxane monomer having at least one silane functional group, a hydrosilylation catalyst, and a radical initiator;
forming the 3D structure using the composition as a resin and/or ink with an additive manufacturing process; and
curing the formed 3D structure for forming a siloxane elastomer material.

19. The method as recited in claim 18, wherein the radical initiator comprises a photoactivated initiator and/or a thermally activated initiator,
wherein the curing includes exposure to light.

20. The method as recited in claim 18, wherein the additive manufacturing technique is direct ink writing, wherein the composition is an ink extruded through a nozzle.
